(19) United States
(12) Patent Application Publication
(10) Pub. No.: US 2003/0133007 A1
(43) Pub. Date: Jul. 17, 2003

(54) IMAGE PICKUP APPARATUS

(76) Inventors: KATSUMI IIJIMA, TOKYO (JP); KATSUHIKO MORI, KAWASAKI-SHI (JP); TAKEO SAKIMURA, URAYASU-SHI (JP)

Correspondence Address: FITZPATRICK CELLA HARPER & SCINTO, 30 ROCKEFELLER PLAZA, NEW YORK, NY, 10112, US

(21) Appl. No.: 09/174,461

(22) Filed: Oct. 19, 1998

(30) Foreign Application Priority Data
Oct. 21, 1997 (JP) 09-305077
Sep. 25, 1998 (JP) 10-271578

(51) Int. Cl. H04N 15/00

(52) U.S. Cl. 348/46; 348/52

(57) ABSTRACT

A right and left camera for picking up images, an image combining circuit for generating a 3-D image by combining right and left images, a 3-D image display for displaying the 3-D image output from the image combining circuit, a display memory for use in displaying the right and left images on the 3-D image monitor, and a recording memory for use in recording the right and left images are shared and double buffer memories are used to perform write and read operations concurrently in alternating manner, allowing the right and left images to be combined and displayed as a 3-D image on the 3-D image display at a high data rate.

### BACKGROUND OF THE INVENTION

1. Field of the Invention

The present invention relates to a camera which allows for photographing and displaying a three-dimensional and a two-dimensional image.

2. Related Background Art

Systems proposed for photographing and displaying so far, a three dimensional image are known, including, for example, a three-dimensional television system disclosed in Japanese Patent Application Laid-Open No. 62-21396.

Such a three-dimensional camera and display system basically acquires a set of images with parallax from more than one cameras and displays them as a three-dimensional image to the operator on a three-dimensional image display dedicated for the system.

Such a conventional three-dimensional camera and display system has a camera for photographing image and a separate display (3-D image display) for displaying a three-dimensional image.

In a situation where the camera is moved for photographing, the display is detached from the system during photographing and re-attached later to monitor images while editing.

However, in prior art systems, such as the one described above, it is difficult to adjust the camera while monitoring images because the operator cannot view images three-dimensionally.

To resolve this problem, the inventor has proposed earlier a 3-D camera and display system in which a camera and a display are combined.

As to the proposed 3-D camera and display system, however, no particular mention has been made of memory capacity and no disclosure has been made of means for using memory effectively.

Providing memory used in displaying an image being photographed on its liquid crystal display means and memory used for storing an image photographed by a camera means separately, wastes memory capacity and increases power consumption and costs.

### SUMMARY OF THE INVENTION

To solve the above-mentioned problem, the present invention has been provided. An object of the present invention is to provide a dual eye image pickup apparatus which uses memory economically to improve memory efficiency.

Another object of the present invention is to provide an unexpensive dual eye image pickup apparatus which improves memory efficiency and reduces power consumption.

According to a preferred embodiment of the present invention, to achieve these objects, an image pickup apparatus is disclosed comprising a plurality of image pickup means for picking-up an image, a display means for displaying the image picked-up by said pickup means, and a plurality of memory means being used both as memory used in displaying the image picked-up by said pickup means and as memory for storing the image picked-up by said pickup means.

A further object of the present invention is to provide an image pickup apparatus which allows for monitoring a 3-D image. According to a preferred embodiment of the present invention, to achieve such object, an image pickup apparatus is disclosed which allows for displaying a 3-D image without time delay by driving said plurality of memory means in a double-buffering manner in which a write-operation and a read-operation are alternately performed.

Other objects and feature of the present invention will be apparent from the following specification and drawings.

### BRIEF DESCRIPTION OF THE DRAWINGS

FIG. 1 shows the configuration of a camera according to a first embodiment of the present invention;

FIGS. 2A and 2B show the configuration of an image pickup optical head assembly according to the first embodiment of the present invention;

FIG. 3 is a block diagram showing system configuration of a camera according to the first embodiment of the present invention;

FIG. 4 is a block diagram of a signal processing circuit in the camera according to the first embodiment of the present invention;

FIG. 5 shows the concept of generating an image to be displayed in the camera according to the first embodiment of the present invention;

FIG. 6 shows an exemplary display of thumbnail images in the camera according to the first embodiment of the present invention;

FIG. 7 is a block diagram of the system configuration of a dual eye camera system according to the present embodiment;

FIG. 8 is a schematic diagram showing the configuration and signal flow of a signal processing circuit according to a third embodiment of the present invention;

FIG. 9 shows a concept of generating an image to be displayed;

FIG. 10 shows the configuration and signal flow of a signal processing circuit according to a fourth embodiment of the present invention; and

FIG. 11 shows the configuration and signal flow of a signal processing circuit according to a fifth embodiment of the present invention.

### DETAILED DESCRIPTION OF THE PREFERRED EMBODIMENTS

Embodiments of the present invention will be described with reference to the drawings.

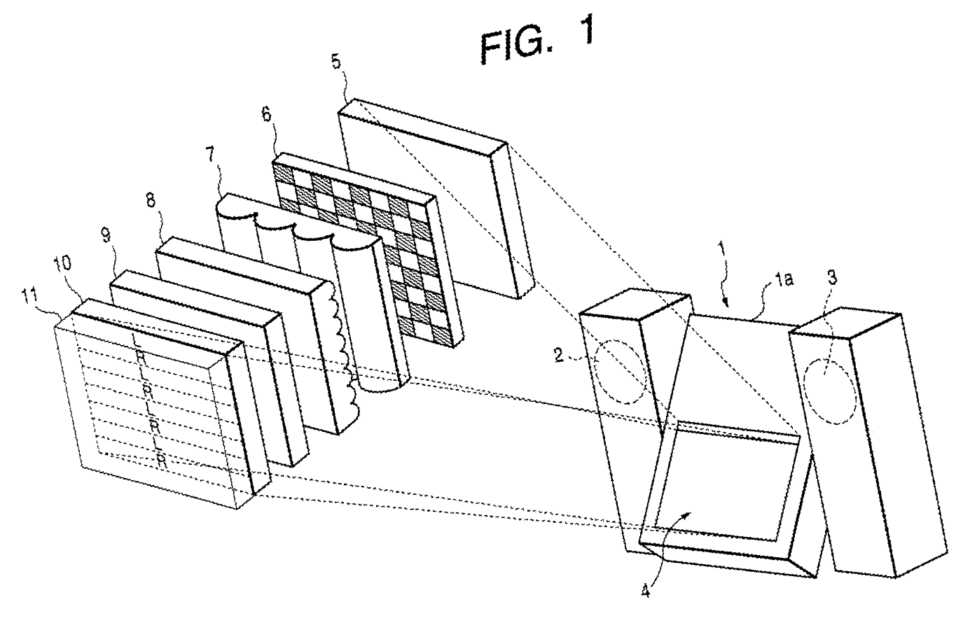

FIG. 1 shows the configuration of a system comprising a camera according to one embodiment of the present invention. In the figure, a camera (dual eye camera) 1 has a camera unit 1a, two image pickup optics (imaging means) 2, 3, and 3-D display device (display means) 4.

The two image pickup optics 2, 3 are used for picking up a picture, and placed to the right and left of the camera unit 1a so as to provide a long baseline length in order to create three-dimensional effect.

The 3-D display device 4 is placed on the camera unit 1a and comprised of a liquid crystal display having a display mode in which an image acquired by the two image pickup optics 2, 3 can be viewed three-dimensionally. The 3-D display device 4 is comprised of a back light 5, mask substrate 6, lenticular lenses 7, 8, a display pixel unit 10 including polymer dispersion liquid crystal 9 and liquid crystal layer, and a glass substrate 11.

The backlight 5 is a light source for the display. The mask substrate 6 has a mask pattern having checkered holes through which light from the back light 5 passes, and is placed in front of the back light. The mask pattern is comprised of metal film or optical absorbing material and formed on the mask substrate 6 of glass or synthetic resin by patterning.

The lenticular lenses 7, 8 are microlenses and made of transparent synthetic resin or glass, orthogonalized with each other, and placed between the substrate 6 and the display pixel unit 10.

The polymer dispersion liquid crystal 9 is placed between the lenticular lenses 7, 8 and the display pixel unit 10.

On the display pixel unit 10, images acquired by the right and left image pickup optics 2, 3 are displayed, being arranged on top of each other alternately to form horizontal stripes, as shown in FIG. 1.

Light from the backlight 5 passes through each of the holes in the mask substrate 6 to lenticular lenses 7, 8, then to the polymer dispersion liquid crystal 9 to illuminate the display pixel unit 10 so that images are separately perceived by the observer's eyes as parallax images. Thus, a 3-D image can be viewed by the observer.

During the above process, electric field is applied to the polymer dispersion liquid crystal 9 so that the light oriented by the mask substrate 6 and lenticular lenses 7, 8 retains its orientation (which allows the images to be separately observed by the operator's eye) while illuminating the display pixel unit 10.

In FIG. 1, components such as polarizing plates, color filters, electrodes, black matrixes, and antireflection film are not shown.

During photographing, the operator can monitor 3-D images acquired by the image pickup optics 2, 3 on the 3-D display device 4. The relative position of the two image pickup optics 2, 3 and the 3-D display device 4 can be adjusted to the position of the observer with respect to the tilt direction, as shown in FIG. 1.

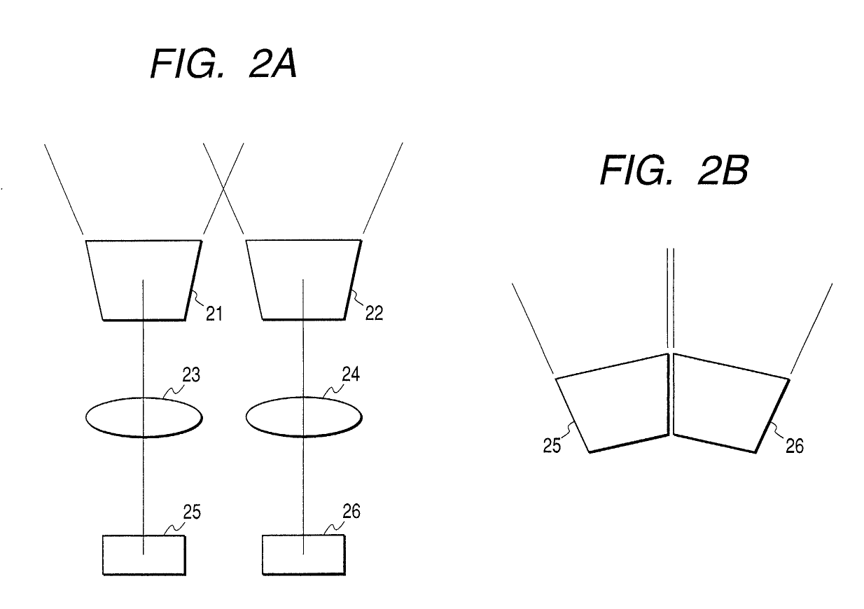

The relative position of the two image pickup optics 2, 3 can be changed as shown in FIGS. 2A and 2B. The purpose of this is to allow for both panoramic imaging and 3-D imaging. FIG. 2A shows the 3-D imaging state, and FIG. 2B shows the panoramic imaging state.

The arrangement of the image pickup optics block will be described with reference to FIGS. 2A and 2B. In FIGS. 2A and 2B, mirrors 21, 22, optic block (lenses) 24, and charge-coupled devices 25, 26 (image pickup devices) are shown.

During panoramic imaging, mirrors 21, 22 are positioned as shown in FIG. 2B and produce a condition as if the system were photographing a scene from a single viewpoint.

During image picking-up or playback operation, the 3-D display device 4 shown in FIG. 1 is used to monitor 3-D images. This is accomplished by providing a 3-D image signal from the storage medium in the camera unit la to the 3-D display device 4.

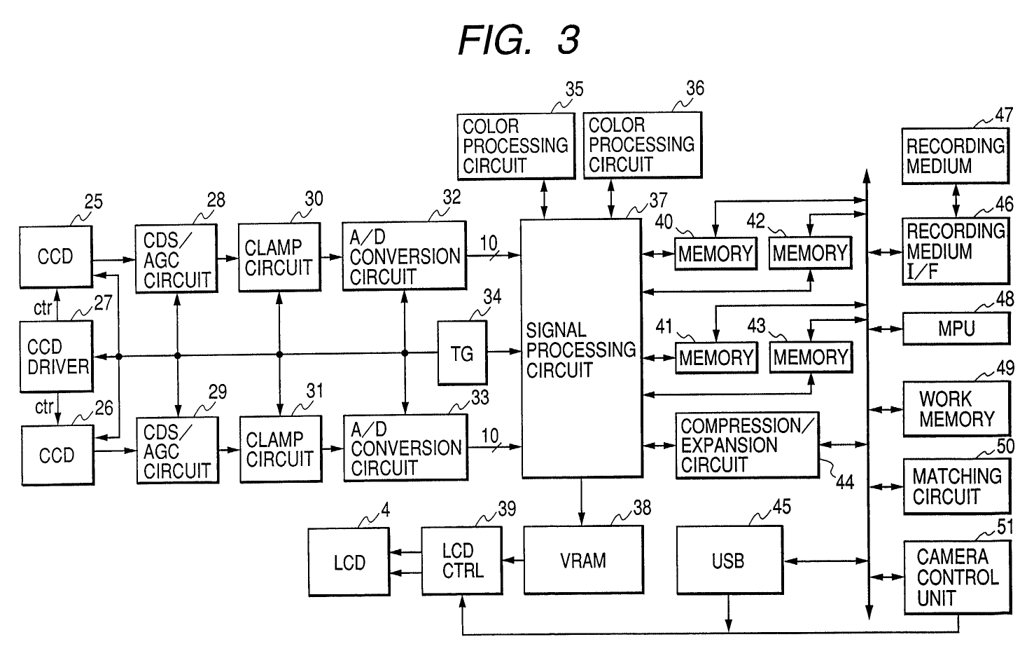

The signal flow and process flow in the camera 1 will be described with reference to FIG. 3. FIG. 3 is a block diagram showing the configuration of a system comprising a camera according to the present embodiment.

Shown in FIG. 3 are image pickup devices 25 and 26, such as charge coupled devices, a vertical CCD driver 27 for the charge coupled devices 25, 26, correlation dual sampling (CDS)/automatic gain control (AGC) circuits 28, 29, clamping circuits 30, 31, analog (A)/digital (D) conversion circuits 32, 33, a timing generator (TG) 34, color processing circuits 35, 36, a signal processing circuit 37, video random access memory (VRAM) 38, a liquid crystal display control circuit (LCD ctrl) 39, a liquid crystal display (LCD) 4 which is a 3-D display device, memories (process memories) 40, 41, 42, 43, and compression/expansion circuit 44 which performs, for example, JPEG (Joint Photographic Experts Group) compression are shown. An interface 45, such as a Universal Serial Bus (USB), a recording medium interface (I/F) 46 which interfaces to a storage medium 47 described bellow, a recording medium 47, such as flash memory, a microprocessor unit (MPU) 48, work memory 49, a matching circuit 50, and a camera control unit 51.

Initially, when the operator inputs an operation such as an image record or write operation through the camera control unit 51, a signal corresponding to the input is sent from the camera control unit 51 to the MPU 48, which in turn controls individual components. In this example, it is assumed that 3-D imaging mode is selected.

Images captured by the two image pickup optics 2, 3 shown in FIG. 1 are formed the CCDs 25, 26. The CCDs 25, 26 perform photoelectric conversion of the image signal. The converted right and left image signals are transmitted through the subsequent CDS/AGC circuits 28, 29 and the clamp circuits 30, 31 and converted into digital signals by the A/D conversion circuits 32, 33, respectively. During this process, the right and left image signals are synchronized and driven by a control from the timing generator 34 and the CCD vertical driver 27, thus the right and left signals processed are of the images picked up at the same time point.

The CCDs 25, 26 operate in flame store mode and field store mode. In this example, it is assumed that they switch from one mode to another between displaying an image on the 3-D display device 4 and storing the image. Through-display operation is performed in field store mode.

The right and left image signals which are converted to digital signals by the A/D conversion circuits 32, 33 are sent to the respective color processing circuits 35, 36 through the signal processing circuit 37. Processes, such as a color conversion process are applied to the digital signal in the color processing circuits 35, 36. The processed right and left digital signals are sent through the signal processing circuit 37 to the memories 40, 41 and stored.

Here, the image from one CCD 25 is stored in the memory 40 and the image from the other CCD 26 is stored in the memory 41. For the next field, an image from one CCD 25 is stored in the memory 42 and an image from the CCD 26 is stored in the memory 43. In this way, images are stored in the memories 40 and 42 alternately on a field basis. The above description also applies to the memories 41 and 43.

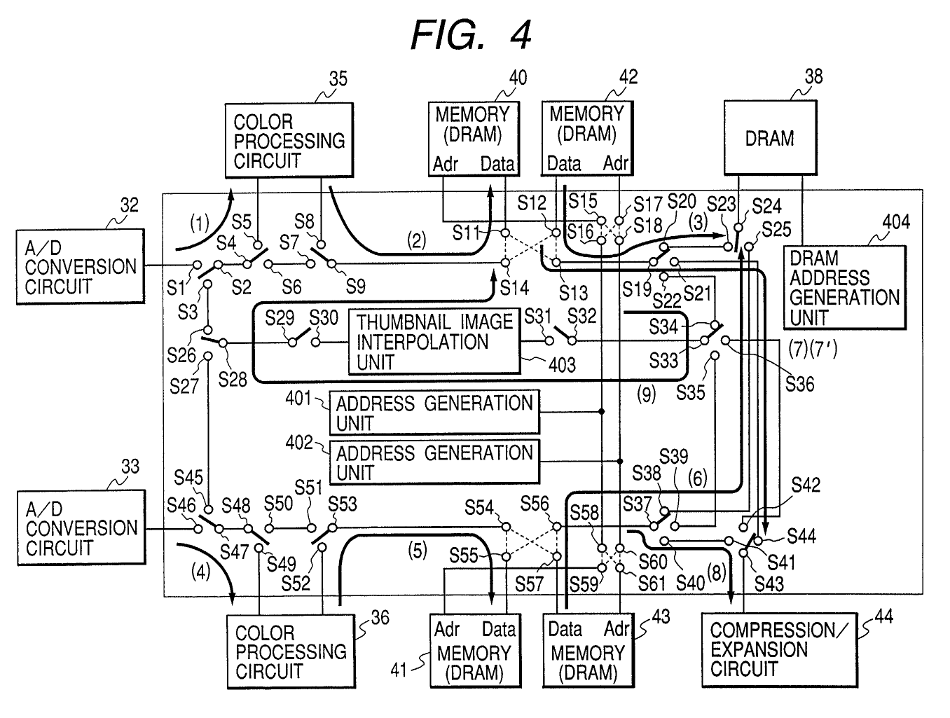

While images are stored one after another, addresses for data to be read from memories which are not in use for store operation, for example, the memories 42, 43, are output from address generation units 401, 402 as described below with reference to FIG. 4, in such a manner that the images are read inversely according to the addresses.

Thus, in a given field, memories 40, 41 on one hand are used for write operation, and memories 42, 43 on the other hand are used for read operation. In this way, read and write operations are alternately repeated. Because images are read inversely, the mirrors 25, 26 (FIGS. 2A and 2B) in the image pickup head are used to return them to normal images.

In the signal processing circuit 37, the read images are transformed to images with a size corresponding to the pixel size of the 3-D display device 4 and the right and left images are combined together line by line, aligned on top of each other and transferred to VRAM 38. The signal processing circuit 37 performs signal processing in both directions.

At this point, the signal from the CCD 25, 26 have been held as images in the respective memories 40, 41 or the memories, 42, 43, respectively, and in the VRAM 38.

To generate 3-D image signal for displaying on the LCD 4 of the camera 1, data contained in the VRAM 38 is used. The VRAM 38 is a display memory and has capacity adequate to display the images on the LCD 4.

The number of pixels held in the memories 40, 41 or the memories 42, 43 and the numbers of pixels of an image displayed on the LCD 4 are not necessarily the same. Therefore, the signal processing circuit 37 provides pixel skipping or interpolation.

The right image and left image written in the VRAM 38 are alternately displayed, one on each scanning line, on the LCD 4 through the LCD control circuit 39. This allows the observer to view 3-D images.

A process flow in the signal processing circuit 37 will be described with reference to FIG. 4. FIG. 4 shows the signal processing circuit 37 having address generation units 401, 402, a thumbnail image interpolation unit 403, a VRAM address generation unit 404, a vertical adder unit 405, and contact terminals S1 to S61.

The contact terminal S1 is connected to a first A/D conversion circuit 32 and the contact terminals S46 is connected to a second A/D conversion circuit 33. The contact terminals S5 and S8 are connected to one color processing circuit 35 and the contact terminals S49 and S52 are connected to the other color processing circuit 36. The contact terminals S11 and S15 are connected to a first memory (DRAM) 40, the contact terminals S55 and S59 are connected to a second memory (DRAM) 41, the contact terminals S12 and S17 are connected to a third memory (DRAM) 42, and the contact terminals S57 and S61 are connected to a fourth memory (DRAM) 43, respectively.

The contact terminal S43 is connected to the compression/expansion circuit 44. The contact terminal S24 and the VRAM address generation unit 404 are connected to the VRAM 38. The contact terminals S16 and S58 are connected to one address generation unit 401 and the contact terminals S18 and S60 are connected to the other address generation unit 402. The contact terminals S30 and S31 are connected to the thumbnail interpolation unit 403.

In FIG. 4, a digital signal from one A/D conversion circuit 32 is transmitted through the contact terminals S1, S2, S4, and S5 (path (1)) to one color processing circuit 35, where processes such as a color conversion are applied to the signal. The processed digital signal is transmitted through the contact terminals S8, S9, S14, and S11 (path (2)) to the first memory (DRAM) 40 and stored in it. The address to be written is generated by one address generation unit 401.

Concurrently, the image which has been stored in the third memory (DRAM) 42 in the preceding field is read by generating its address by the other address generation unit 402 in such a manner that desired processes such as pixel thinning-out and combination are performed, and is transmitted through the contact terminals S12, S13, S19, S20, S23, and S24 (path (3)) to the VRAM 38.

The digital signal from a second A/D conversion circuit 33 is transmitted through the contact terminals S46, S47, S48, and S49 (path (4)) to a second color processing circuit 36, where processes such as color conversion are applied to the signal. The processed digital signal is transmitted through the contact terminals S52, S53, S54, and S55 (path (5)) to the second memory (DRAM) 41 and stored in it. The address to be written is generated by the address generation unit 402.

The image which has been stored in the fourth memory (DRAM) 43 in the preceding field is read simultaneously by generating its address by one address generation unit 401 in such a way that desired pixel thinning-out and combination are performed, then transmitted through the contact terminals S57, S56, S37, S38, S25, and S24 (path (6)) to the VRAM 38.

The address for the signal transmitted through path (3) is generated by the VRAM address generation unit 404 and data from path (3) or path (4) is written to the VRAM 38 by switching in such a way that the right and left images are directed to respective paths.

The term “switching” herein refers to alternately transferring the signals to the VRAM 38 so that, for example, the right and left images are combined together, line by line, aligned on top of each other.

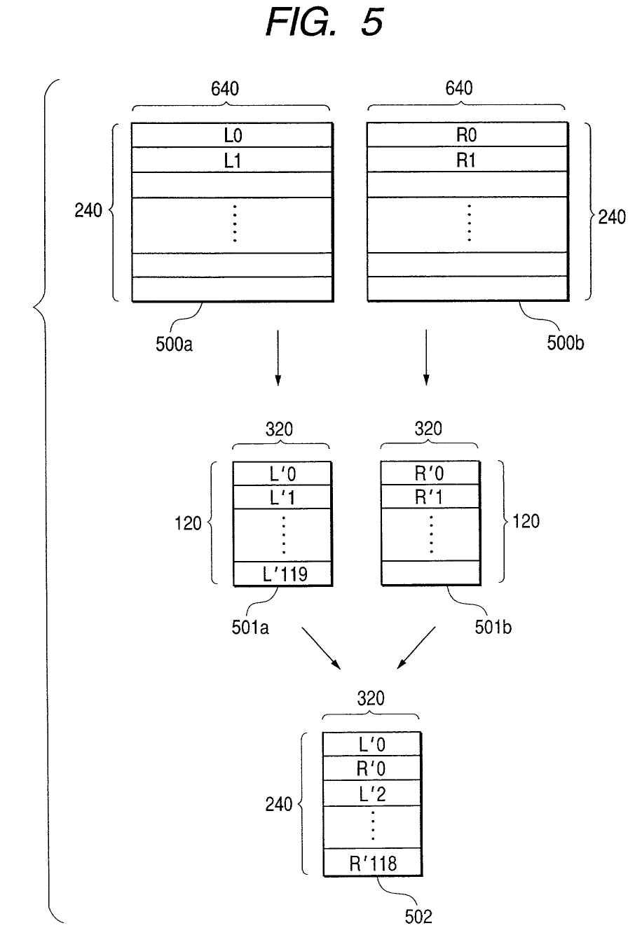

FIG. 5 shows the generation of a combined image. Shown in the figure are images 500a, 500b acquired by the CCDs 25, 26 of FIG. 3, images 501a, 501b compressed into half in size of longitudinally and horizontally, and an interlaced image 502.

In the following description, it is assumed that the number of effective pixels in CCDs 25, 26 is 640×240 (per field) and the number of pixels displayed on the LCD 4 is 320×240.

The right and left pictures imaged on the CCDs 25, 26 by the image pickup optics 2, 3 of FIG. 1 are converted into digital signals and undergo color conversion, as described above, resulting in effective 640×240 pixels (L0, L1, . . . L239 and R0, R1 . . . R239 for each line) as shown by images 500a and 500b.

While these signals are transmitted through the signal processing circuit 37 of FIG. 3 and are held in the memories 40, 41 or the memories 42, 43 without being changed, the respective right and left images 500a, 500b are converted into images 501a, 501b of size 320×240 pixels (L′0, L′1 . . . L′129 and R′0, R′1 . . . R′129) to accommodate to the size of the LCD 4.

This conversion may be simple pixel thinning-out or interpolation. Then, the right and left images 501a, 501b which are converted into 320×240 images are combined together in alternating sequence like L′0, R′0, L′2, R′2, R′238, one for each line, as shown by image 502. The combined image is written in the VRAM 38.

When the operator select the 3-D imaging mode through the camera control unit 51 in FIG. 3, the selection is communicated to the LCD control circuit 39 and an electric field is applied to the polymer dispersion liquid crystal 9 in FIG. 1. That is, two signals, an image signal to be displayed and a control signal for controlling the polymer dispersion liquid crystal 9, are output from the LCD control circuit 39. Thus, as described above, the operator can view the image three-dimensionally.

Recording the image will be described bellow. Although flash memory is used in this example, any types of storage media, including a magnetic tape, magnetic disk, optical disk, semiconductor memory, may be used as the recording medium.

The recording medium I/F 46 in FIG. 3 allows for holding a 3-D image signal in digital form in its available space as a file and also registering it in its file management area.

The process is initiated by the operator inputting the desired operation, that is, initiation of the recording, through the camera control unit 51. When the input is identified by the MPU 48, the CCDs 25, 26 switch their mode from the field store mode to the frame store mode and images are stored in the memories 40-43 through the process described earlier.

Suppose that each of the memories 40, 41 has a capacity which can contain one field from the CCD. Frame store mode requires a capacity two times as much as the field store mode. Here, the dual eye operation in frame store mode requires a store capacity which is equivalent to two frames. That is, a capacity required for holding two frames is equivalent to a capacity required for four fields, therefore, all of the memories 40-43 are used.

The data held in the VRAM 38 is displayed on the LCD 4 without being changed. A data flow from the memory such as memory 40, which was being used until the recording operation has started, is stopped and a still image is displayed on the LCD 4.

The data stored in the memories 40, 42 out of the memories 40-43 is first sent through the signal processing circuit 37 to the compression/expansion circuit 44, where the data is compressed, and the compressed data is stored in the work memory 49. This is done along path (7) through the contact terminals S12, S13, S19, S21, S44, and S43 shown in FIG. 4.

Next, the data in the memories 41, 43 is sent through the signal processing circuit 37 to the compression/expansion circuit 44, where the data is compressed, and the compressed data is stored in the work memory 49. This is done along path (8) through the contact terminals S57, S56, S37, S40, S41, and S43 in FIG. 4. In this example, it is assumed that JPEG compression is performed.

The compressed data is held in the work memory 49. A file name, for example, s001L.jpg or s001R.jpg, is assigned to the data and the two files of compressed right and left images are paired and stored so that they can be managed as a pair. An identifier for identifying the pair is also stored in the file management area.

In addition, a thumbnail image is stored along with the above-mentioned image. The thumbnail image is a reduced image of the original image, for example, an image of 80×60 pixels.

The thumbnail image is compressed in a similar way to how the original image is compressed. First, the data stored in the memories 40, 42 out of the memories 40-43 is reduced to an image of size 80×60 pixels by the signal processing circuit 37. This is done along path (9) through the contact terminals S12, S13, S19, S22, S34, S33, S32, S31 to the thumbnail image interpolation unit 403 to the contact terminals S30, S29, S28, S26, S3, S2, S4, S6, S7, S9, S10, S11 in FIG. 4.

The data is then sent to the compression/expansion circuit 44 (this is done along path through the contact terminals S12, S13, S19, S21, S44, and S43), where the data is compressed and the compressed data is stored in the work memory 49.

Next, the data stored in the memories 41, 43 are reduced to an image of size 80×60 pixels by the signal processing circuit 37. The reduced data is sent to the compression/expansion circuit 44, where the data is compressed, and the compressed data is stored in the work memory 49. In this example, JPEG compression is performed.

The compressed data is held in the work memory 49. As a file name, for example, ss001L.jpg or ss001R.jpg, is assigned to the data and the two files of right and left thumbnail images are paired and stored so that they can be managed as a pair. An identifier for identifying the pair is also stored in the file management area.

The flow of 3-D image recording operation has been described. The user of the camera 1 can monitor the 3-D image displayed on the LCD 4 and perform recording operation only when the user desires to do. This provides flexibility when photographing and allows the user to monitor 3-D effect while moving the camera 1 for photographing.

In addition, memories are economically used by sharing the memories between display operation and recording operation as described above.

Reproduction of the 3-D image stored in the recording medium 47 will be described bellow. Because more than one 3-D image files are stored in the recording medium 47, the management area in the recording medium 47 is first accessed by the I/F 46 and image file registration data is read out and sent to the MPU 48.

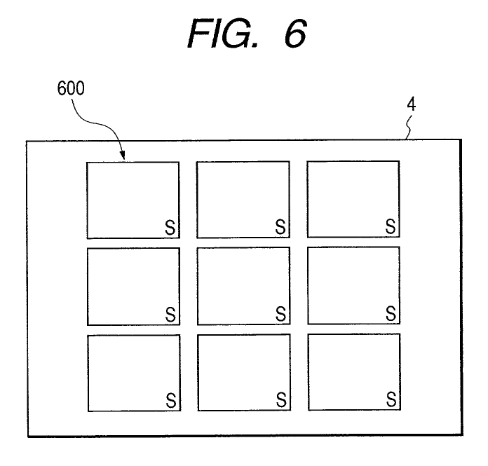

The MPU 48 selects the identifier of an image file that can be reproduced as a 3-D image and formats the image data corresponding to the file identifier into a particular display format. Its associated thumbnail file is read from the recording medium 47 and stored in the work memory 49. Because the thumbnail image stored in the work memory 49 is compressed according to JPEG, the nine thumbnail images are selected and sent to the signal processing circuit 37, then displayed on the LCD 4 as shown in FIG. 6. Because the LCD 4 is now in 2-D display mode, the thumbnail images are displayed along with their flag information that indicates that they are 3-D images.

Thumbnail images 600 and flags S indicating that the image a 3-D image is shown in FIG. 6. The operator selects an image file from the displayed thumbnail images, which he/she wants to playback and input the selection through the camera control unit 51. The input signal is sent from the camera control unit 51 to the MPU 48. Then, the data of the selected file is read from the recording medium 47 through the recording medium I/F 46 and transferred to the work memory 49. Then, the data in the work memory 49 is decompressed by the compression/expansion circuit 44 and sent to the memories 40, 41. The data undergoes size transformation and interlace combination and is stored in the VRAM 38, then displayed on the LCD 4 as a 3-D image.

In this way, the 3-D image photographed by the system can be easily reproduced. In addition, 3-D sound can be produced together with 3-D images by disposing a microphone (not shown) along with each image pickup optics 2, 3.

A second embodiment of the present invention will be described below. Although the VRAM 38 is used in the first embodiment described above, the present invention may be practiced without the VRAM 38.

In the following description, an embodiment which does not use the VRAM 38 will be described. The basic configuration of the camera according to the second embodiment is the same as the first embodiment described above, except that the VRAM 38 is omitted. The drawings used for describing the first embodiment is also used in the description of the second embodiment, as necessary.

Images acquired by the CCDs 25, 26 shown in FIG. 3 are converted by the A/D conversion circuits 32, 33 to digital signals, then color conversion process is performed in the color processing circuits 35, 36. Until this point, the process is the same as the first embodiment described above.

The processed right and left digital signals are sent to the signal processing circuit 37, then sent to the memories 40, 41 and the memories 42, 43 alternately and stored. This process is also similar to the first embodiment. The second embodiment differs from the first embodiment in read operation.

In the first embodiment, addresses to be read are output from an address encoder (not shown) in such a manner that images are inverted. The images in inverted form are read every second line from, for example, the memories 42, 43 used for read operation, according to the addresses output from the address encoder (not shown) and transferred to the LCD controller 39 so that the right and left images are combined in alternate order, line by line.

Although images are inverted in read operation in the first and second embodiments, the present invention is not limited to such implementation. Instead, the image may be inverted in write operation and read operation may produce a normal image.

As described above, 3-D images can be monitored on the 3-D display device while the 3-D images are being photographed. In addition, the 3-D images can be photographed at lower cost and lower power consumption by using the memories both for recording operation and for through-display operation.

A third through fifth embodiments of the present invention will be described bellow. The above-mentioned embodiments pose certain problems. In the above-mentioned embodiments, although the two image pickup systems perform imaging operation in synchronization with each other to output image signal concurrently during dual eye image pickup operation and LCD display operation, the subsequent process is performed along one path at a time. Therefore, the sizes of 3-D or panoramic image display and display rate cannot be increased.

The above-mentioned problems are caused by the dual eye, synchronous imaging. In the case of single eye imaging, the display size and display rate are determined only by the number of pixels in the image pickup device and the throughput of the subsequent stages.

Adding memory to record images will result in uneconomical memory capacity usage, as well as increased power consumption and cost of the system.

To solve these problems, according to the third and fourth embodiments, memory capacity is not added more than is necessary and uses memory effectively without lowering the performance, and, as a result, an inexpensive and low power consumption image pickup system is provided.

In particular, an image pickup system is disclosed which comprises a plurality of image pickup means, a plurality of buffer memory means for temporarily storing image data output from said imaging means, and image combining means for combining image data read from said buffer memory means.

Furthermore, an image pickup system is disclosed which comprises a 3-D display capable of displaying 3-D images; a buffer memory means used as a double buffer which is switched between write and read uses, the buffer memory means temporarily stores image data from said plurality of image pickup means; and an image combining means for combining image data read from said buffer memory means.

Furthermore, an image pickup system is disclosed which comprises right and left image pickup means; right and left buffer memory means for temporarily storing image data output from said right and left buffer memory means, respectively; and image combining means for combining image data read from right and left buffer memory means; wherein each of said right and left memory means has a plurality of memories and is arranged in such a manner that write and read operations of image data can be performed concurrently at predetermined periods, and said image combining means is arranged in such a manner that image data output from said right and left buffer memory means can be combined and output from at predetermined periods.

Furthermore, an image generating method is disclosed which comprises steps of; storing image data output from a plurality of image pickup means in a plurality of buffer memory means; and combining image data read from each of said plurality of buffer memory means to generate a 3-D or panoramic image; wherein each of said plurality of buffer memory means is comprised of a plurality of memories, write and read operations of image data can be performed concurrently at predetermined periods, and image data output from each of said plurality of buffer memory means are combined and output at said predetermined periods.

The third, fourth, and fifth embodiments will be described below.

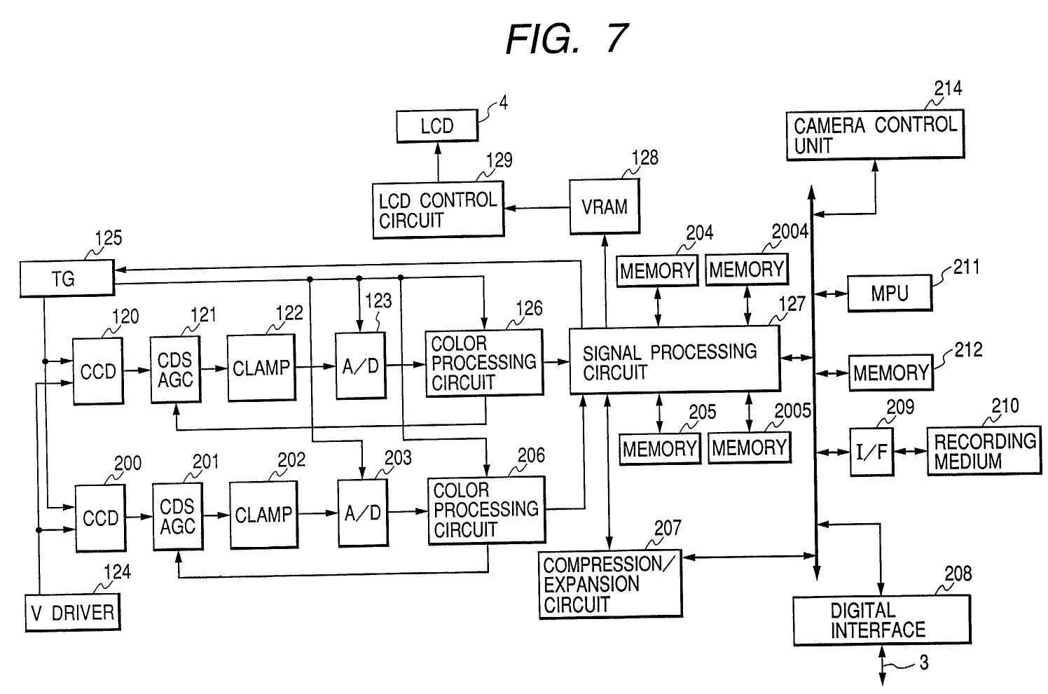

Referring to FIG. 7, which shows the third embodiment of the present invention, a signal flow and process flow in a camera during 3-D imaging is described.

Shown in FIG. 7 are image pickup devices 120, 200 such as CCDs (image pickup means of the present invention), a vertical driver 124 for the CCDs, CDS/AGC circuits 121, 201, clamp circuits 122, 202, A/D conversion circuits 123, 203, a timing generator 125, color signal processing circuit 126, 206, a signal processing circuit 127, a VRAM 128, and a LCD control circuit 129 which drives and controls display elements of the LCD device 4 shown in FIG. 1 capable of displaying 3-D images.

Also shown are process memories 204, 205, 2004, 2005 which make up the buffer memory of the present invention, and a compression/expansion circuit 207, which performs, for example, Motion JPEG compression/expansion.

A digital interface 208 (for example, USB interface) an interface 209 for providing access to storage medium, and storage medium 210 (for example, a flash memory) are also shown.

Furthermore, a MPU 211, work memory 212, and a camera control unit 214 are shown.

When the operator inputs an operation such as recording or playback operation through the camera control unit 214, a signal corresponding to the input, is sent from the camera control unit 214 to the MPU 211, which controls individual components in the system. Here, it is assumed that the 3-D imaging mode is selected.

A picture acquired by the two image pickup optics 2, 3 is imaged on the image pickup device, CCDs 120, 200.

The optical image undergoes photoelectric conversion in the CCDs 120, 200 and is output as right and left image signals. The image signals undergo sampling and gain control in the subsequent CDS/AGC circuit 121, 201 (CDS: Correlation Dual Sampling, AGC: Automatic Gain Control), are clamped to a reference level by the clamp circuits 122, 202, then converted into digital signals by the A/D converters 123, 203.

The right and left image signals are synchronized and driven under the control of the CCD vertical driver 124 and the timing generator 125, so that the images which were acquired in the same time point are processed.

CCDs 120, 200 operate in frame store mode and field store mode. In this example, it is assumed that they switch from one mode to another between displaying an image on the LCD and recording the image.

Through-display operation in display device 4 is performed in field store mode.

The right and left image data converted into digital signals by the A/D converter 123, 203 are sent to the color processing circuit 126, 206, respectively, and undergo color processes such as color conversion.

The processed right and left digital signals are sent through signal processing circuit 27 to the memories 204, 205 and stored in them. The image data from the CCD 120 is stored in the memory 204 and the image data from the CCD 200 is stored in the memory 205.

In the next field, the image data from the CCD 120 is stored in the memory 2004 and the image data from the CCD 205 is stored in the memory 2005.

In this way, the memories 204 and 2004 are switched for each field and used for storing image data. This is the same for the memories 205 and 2005.

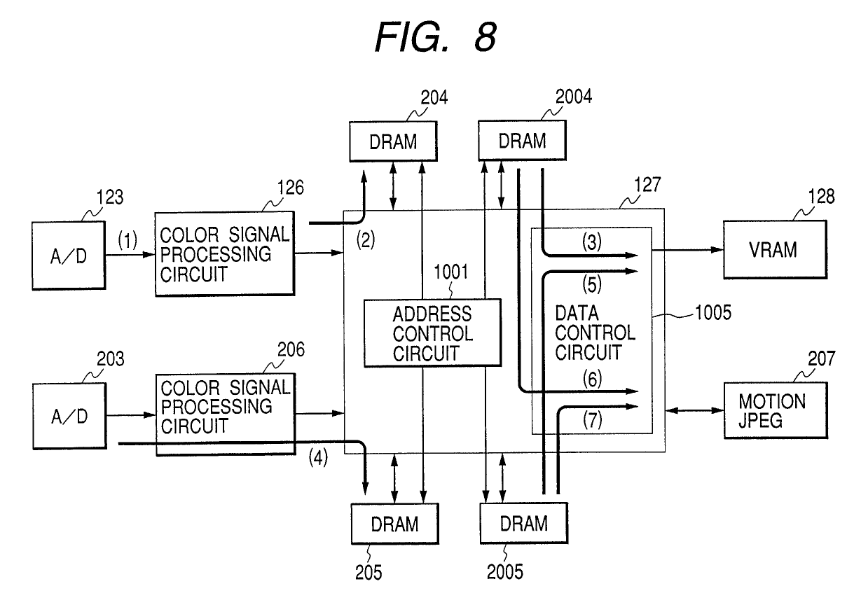

While image data are stored into memories in sequence, stored image data are read from the memories which are not being used for store (for example, the memories 2004, 2005 while the memories 204, 205 are being used for store). Read addresses are output from the address encoders 1001, 1002 described below and shown in FIG. 8 so that images are inverted and read according to these addresses.

Thus, in a given field, memories 204, 205 on one side are used for write operation and memories 2004, 2005 on the other side are used for read, and the read and write operation are repeated alternately. This means that, the memories are uses as a double buffer. (In the present invention, the implementation in which write and read operations are performed by switching memories for read and write is called “double buffer”, which corresponds to the double buffer means of the present invention.)

Since images are read inversely, images which was inverted by the mirrors in the image pickup head are read as normal images.

The read images are transformed into images with a size corresponding to the pixel size of the LCD. The right and left images are combined line by line, aligned on top of each other, and transferred to the VRAM 28. The signal processing circuit 127, thus provides control to the both directions.

At this point, the acquired image signals have been stored as images in the memories 204, 205 or the memories 2004, 2005, as well as in the VRAM 28.

Data in the VRAM 128 is used for creating a 3-D image on the LCD device 4 in the dual eye camera. The VRAM 128 is an image memory for display operation and has a capacity accommodating images displayed on the LCD 4.

Since the number of pixels held in the memories 204, 205 or 2004, 2005 is not necessarily the same as the number of the pixels in an image to be displayed on the LCD device 4, the signal processing circuit 27 provides pixel thinning-out and interpolation.

The right and left images written in the VRAM 128 are displayed alternately, one on each line, on the LCD device 4 through the LCD control circuit 129. Thus, the observer can monitor a 3-D image on the display.

The process flow in the signal processing circuit 127 will be described with reference to FIG. 8. In FIG. 8, an address control unit 1001 and a data control circuit 1005 are shown.

In FIG. 8, same reference numbers are applied to same elements as in the other drawings. Digital signals from the A/D converter 123 are transmitted along path (1) to the color signal processing circuit 126 and undergo processes such as color conversion. The processed digital signals are transmitted through path (2) to the memory 204 and stored in it. Addresses to be written are generated by the address control circuit 1001.

Concurrently, images which have been stored in the memory 2004 in the preceding field are read to undergo processes such as pixel thinning-out and combination, according to addresses generated by the address control unit 1001, then are transferred to the VRAM 28 via path (3).

The above description also applies to signals from the other A/D converter 203, as described above (path (4)).

The address for the signal transmitted through path (3) is generated by the data control circuit 1005 and data from path (3) or path (5) is written to the VRAM 128 by switching in such a way that the right and left images are directed to the respective paths.

The term “switching” herein refers to alternately transferring the signals to the VRAM 128 so that, for example, the right and left images are combined together, line by line, aligned on top of each other.

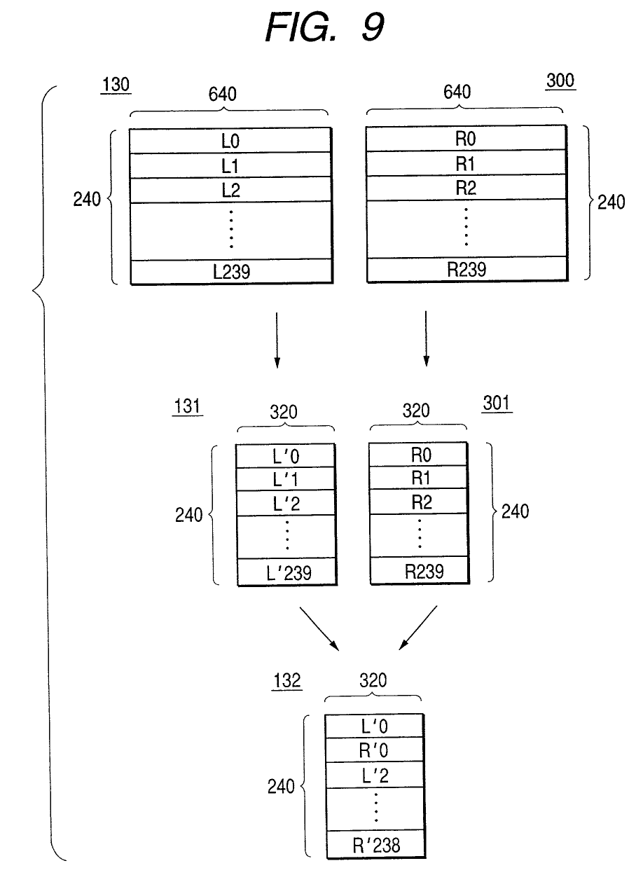

FIG. 9 shows the generation of a combined image more schematically. Shown in the FIG. 9 are field images 130, 300 acquired by the CCDs, and images 131, 301 compressed 2 to 1 horizontally.

In the following description, it is assumed that the number of effective pixels in CCDs is 640×240 (per field) and the number of pixels displayed on the LCD is 320×240.

The right and left pictures imaged on the CCDs by the image pickup optics 2, 3 are converted into digital signals and undergo color conversion, resulting in effective 640×240 pixels (L0, L1, . . . L239 and R0, R1 . . . R239 for each line) as shown by effective pixels 130, 300.

While these signals are transmitted through the signal processing circuit 127 and are held in the memories 204, 205 or the memories 2004, 2005 without being changed, the respective right and left images 130, 300 are converted into images 131, 301 of size 320×240 elements (L′0, L′1 . . . L′239 and R′0, R′1 . . . R′239 for each line) to accommodate to the size of the LCD. This conversion may be simple pixel thinning-out or interpolation.

Then, the right and left images 131, 301 which are converted into 320×240 are combined in alternating sequence like L′0, R′0, L′2, R′2, . . . , R′238, line by line, as shown by image 132. The combined image is written in the VRAM 128.

When the operator select the 3-D imaging mode through the camera control unit 214, the selection is communicated to the LCD control unit 129 and an electric field is applied to the polymer dispersion liquid crystal 9. That is, two signals, an image signal to be displayed and a control signal for controlling the polymer dispersion liquid crystal 9, are output from the LCD control unit 29. Thus, as described above, the operator can view the image three-dimensionally.

Recording the image will be described below. Although flash memory is used in this example, any types of storage media, including a magnetic tape, magnetic disk, optical disk, semiconductor memory, may be used as the recording medium.

The interface 209 to the recording medium 210 allows for storing a 3-D image signal in digital form in its available space as a file, as well as registering it in its file management area.

The process is initiated by the operator inputting an operation which directs the camera control unit 214 to initiate the recording. When the direction is identified by the MPU 211, the CCDs switches their mode from the field store to the frame store mode and images are stored in the memories 204, 205, 2004, 2005 through the process described earlier.

Assuming that each of the memories 204, 205 has a capacity which can contain one field in the CCD, the frame store mode requires a capacity two times as much as the field store mode.

In this case, the dual eye system in frame store mode requires a store capacity that is equivalent to two frames.

That is, a capacity required for holding two frames is equivalent to a capacity required for four fields, therefore, all of the memories 204, 205, 2004, 2005 are used.

The data held in the VRAM 128 is displayed on the LCD without being changed. A data flow from the memory such as memory 204, which was being used until the recording operation has started, is stopped and a still image is displayed on the LCD.

The data stored in the memories 204, 2004 out of the memories 204, 205, 2004, 2005 is first sent through the signal processing circuit 27 to the compression/expansion circuit 207, where the data is compressed, and the compressed data is stored in the work memory 212. This is done through path (6) in FIG. 8.

Next, the data in the memories 205, 2005 is sent through the signal processing circuit 27 to the compression/expansion circuit 207, where the data is compressed, and the compressed data is stored in the work memory 212. This is done through path (7) in FIG. 8.

In this example, it is assumed that Motion JPEG compression is performed. The compressed data (which is equivalent to one frame or one field data) is held in the work memory 212. A file name, for example, s001L.Mjpg or s001R.Mjpg, is assigned to the compressed data. The first frame or field is written as above-mentioned file.

The data of the subsequent frames or fields sent in sequence are also written after the first file. The written right and left compressed motion picture images are managed as a pair of files.

At the same time, an identifier for identifying the pair is also stored in the file management area. In addition, a thumbnail image is stored along with each image. Furthermore, a thumbnail image is stored with the above-mentioned image.

The thumbnail image is a reduced image of the first frame (or field) of motion picture. Here, the thumbnail is a reduced image of the frame of both of the right and left, or, for example, left motion picture image. The size of a thumbnail is, for example, 80×60.

The thumbnail image is compressed in a similar way to how the original image is compressed. First, the image stored in the memories 204, 2004 is first reduced to an image of size 80×60 pixels by the signal processing circuit 127. Then, the reduced image is sent to the compression/expansion circuit 207 and compressed, then the compressed data is stored in the work memory 212.

In the following description, it is assumed that only one frame (left frame) is compressed according to Motion JPEG compression (this is the same as the JPEG compression).

The compressed data is held in the work memory 212. Each data is assigned a file name, for example, ss001L.mjpg, and managed as a compressed thumbnail image file.

At the same time, an identifier for identifying the right and left motion images is stored in the file management area.

The flow of 3-D motion picture recording process has been described. The user of the camera can monitor the 3-D image displayed on the LCD and perform recording operation only when the user desires to do.

This provides flexibility during photographing, allowing the user to monitor 3-D effect while moving the camera 1 for photographing.

Playback process of 3-D images recorded in the recording medium 210 will be described briefly.

Because more than one 3-D image file is stored in the recording medium 210, the management area in the recording medium 210 is first accessed by the memory I/F 209 to read image file registration data and send it to the MPU 211.

The MPU 211 selects the identifier of an image file that can be reproduced as a 3-D image and formats the image data associated with the file identifier into a particular display format. Its associated thumbnail file is read from the recording medium 210 and stored in the work memory 212.

Because the thumbnail image stored in the work memory 212 is compressed according to JPEG (Motion JPEG of one frame), the nine thumbnail images are selected and sent to the signal processing circuit 127, then displayed on the LCD as shown in FIG. 6.

Because the LCD 4 is now in 2-D display mode, the thumbnail images are displayed along with their flag indicating that they are 3-D images.

Thumbnail images 600 and flags S indicating that the image is a 3-D image are shown in FIG. 6. The operator selects an image file from the displayed thumbnail images, which he/she wants to playback and input the selection through the camera control unit 214.

The input signal is sent from the camera control unit 214 to the MPU 211. Then, the motion picture data of the selected file is read on a frame basis from the recording medium 210 through the memory I/F 209 and transferred to the work memory 212.

Then, the data in the work memory 212 is decompressed on a frame basis by the compression/expansion circuit 207 and sent to the process memories 204, 205.

The data undergoes size transformation and interlace combination and is stored in the VRAM 128, then displayed on the display 4 as a 3-D image.

The subsequent frame is processed similarly and motion picture is reproduced by repeating this process. In this way, the 3-D image photographed by the system can be easily displayed.

In addition, 3-D sound can be produced with 3-D images by disposing a microphone (not shown) along with each image pickup optics 2, 3.

According to the above-mentioned arrangement, an image acquired by the CCD 23 is sent through the color processing circuit 26 to one of the memories 204, 2004 at field periods and stored, while an image written in the preceding field period is read from the other memory which is not being used for write and provided to the data control circuit 1005 at field periods.

On the other hand, an image acquired by the CCD 203 is sent through the color processing circuit 206 to one of the memories 205, 2005 at field periods, while an image written in the preceding field period is read from the other memory which is not being used for write and provided to the data control circuit 1005 at field periods, then combined with a field image provided from the memory 204, 2004.

Images from the both CCDs are acquired at the same time, thus a 3-D image can be monitored at field periods by combining these images and storing the combined image in the VRAM 128, and the 3-D motion picture can be displayed by switching the memories efficiently.

In addition, for recording images in the recording medium, 3-D frame images can be recorded along with their attributes and identification by using the four memories.

In the third embodiment described above, a 3-D LCD is used as a display. In a fourth embodiment of the present invention, instead of using the display, liquid crystal shutter goggle may be used to monitor a 3-D image output from the camera.

In the fourth embodiment, unlike the signal flow shown in FIG. 8 which right and lift images are switched in line order, right and left images are switched on a frame basis.

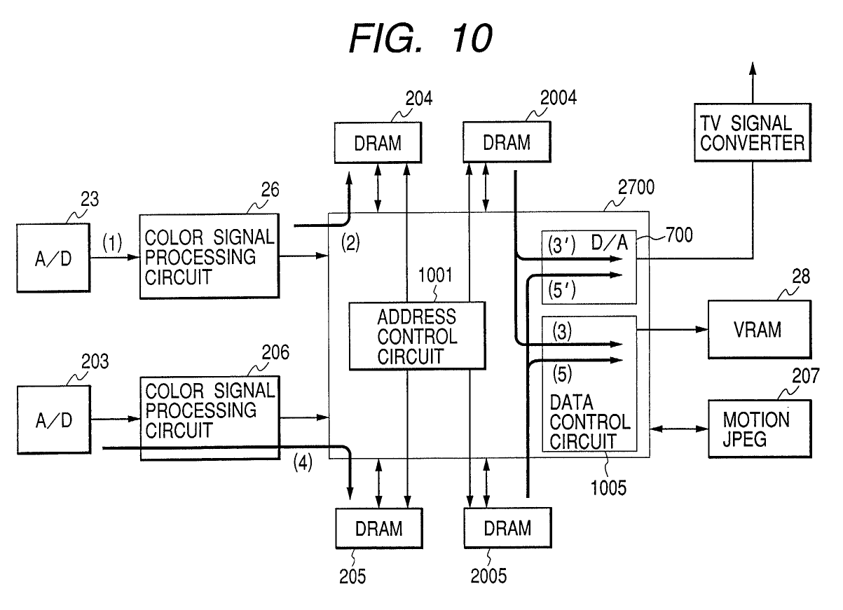

The fourth embodiment will be described in conjunction with a signal flow with reference to FIG. 10.

A difference from the arrangement in FIG. 8 is in that the signal is output to a D/A converter 700, besides a VRAM 128.

The digital signal from the A/D converter 123 is transmitted along path (1) to a color processing circuit 126 and undergoes processes such as color processing.

The processed digital signal is transmitted along path (2) to memory 204 and stored. The write address is generated by an address control circuit 1001.

An image which has been stored in memory 2004 in the preceding field is read simultaneously by generating the address by an address control unit 1001 in such a way that desired processes such as pixel thinning-out or combination are performed, and is sent to the VRAM 128 through path (3).

The above description also applies to a signal from the other A/D converter 203, as described earlier.

On the contrary, a signal output to the VRAM 128 is only from path (3).

To the D/A converter 700, a signal from path (3)′ or (5)′ is provided by switching so as to the right and left images are provided alternately.

Here, “switching” means that the right and left images are transmitted to the D/A converter 700 in such a manner that, for example, right and left fields are alternately provided on a field basis.

Thus, one of right and left images is output to the LCD from the camera through the D/A converter 700 in field sequence, and becomes TV signals, which can be seen as a 3-D image through the liquid crystal shutter goggle.

In the third and fourth embodiments described above, double buffers are used in the stage subsequent to the color signal processing circuit. In a fifth embodiment of the present invention, double buffers may be used immediately after the A/D converters 123, 203.

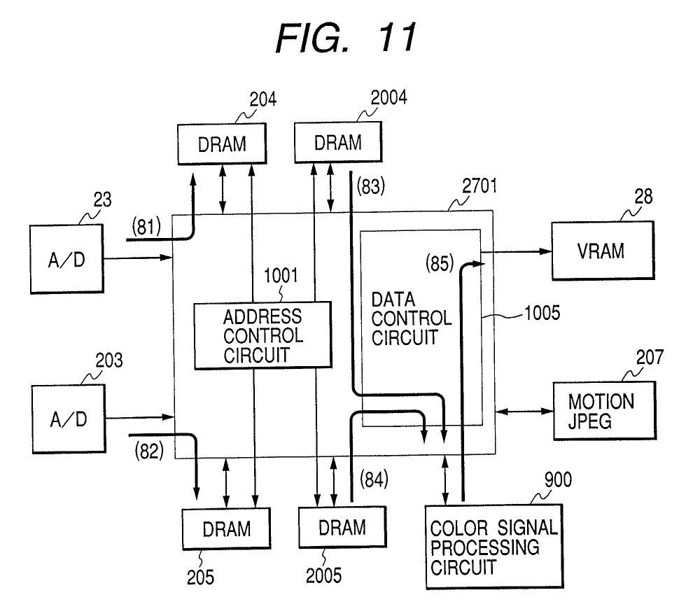

FIG. 11 shows this embodiment. In FIG. 11, a color signal processing circuit 900 is shown. A digital signal from an A/D converter 23 is transmitted along path (81) to one of the double buffers 204, 2004 and written in it.

Similarly, a digital signal from the other A/D converter 203 is sent, for example, to the double buffer 205 and written in it (path (82)).

A digital signal is read from the other memory (in this time, memories 2004, 2005) (through path (83), (84)), output to the color conversion circuit 900, and processed with color conversion.

Concurrently, data is read from each of the right and left buffer memories which are not being used for write operation.

Which of the right and left image data is provided to the color signal processing circuit (selection of path (83) or (84)) is determined by line sequence in the case where display device is used as in the first embodiment, or by field sequence in the fourth embodiment.

After the color signal processing, the desired pixel thinning-out is performed, and the processed signal is sent through an interpolation circuit to the VRAM (path (85)).

After the color signal processing circuit 900, this path is advantageously common to both the right and left image signals.

With respect to the third, fourth, and fifth embodiments, it has been described that the image is inverted during read operation. However, the inversion may be performed in write operation image and a normal image may be produced in read operation.

Although a double buffer is used in the stage subsequent to the A/D converter in the embodiments described above, the double buffer may be positioned after a pixel skipping circuit or interpolation circuit.

Although in the embodiments described above, four DRAMs are used to implement the double buffers, the number of memory elements is not limited to physically four. Instead, any implementation which provide double buffering may be used. For example, in large-capacity memory, essentially four memories may be arranged to functionally provide double buffering.

In the above-described embodiments, the present invention is described with respect to generating a 3-D image. The present invention, however, is also applicable to other image generation such as a panoramic image.

As described above, the camera of the present invention allows the user to monitor 3-D image on the 3-D display while photographing the 3-D image, with checking how the 3-D effect is produced. In addition, the present invention provides effective memory usage by using memories as double buffers for recording and through-display operation, allowing 3-D images to be produced in real time at lower power consumption and cost.

Many widely different embodiments of the present invention may be constructed without departing from the spirit and scope of the present invention. It should be understood that the present invention is not limited to the specific embodiments described in the specification, except as defined in the appended claims.

What is claimed is:

1. A camera comprising:
a plurality of image pickup means for picking up an image;
display means for displaying an image picked up by the image pickup means; and
a plurality of memory means being used both as display memory in displaying the image picked up by said image pickup means and as recording memory for recording the image acquired by said image pickup means.

2. A camera according to claim 1, wherein when said plurality of memory means are used in displaying the image picked up by said image pickup means, some of said plurality of memory means are used for write operation and the others of said plurality of memory means are used for read operation by switching between the write and read operations, whereby said plurality of memory means are used as a double buffer.

3. A camera according to claim 1, wherein when said plurality of memory means are used for recording the image picked up by said image pickup means, all of said plurality of said memory means are used for write operation in order to record each image acquired by said plurality of image pickup means, and after said write operation is completed, all of said memory means are used for read operation.

4. A camera according to claim 2, wherein the image is written in said double buffer in normal form and the image is read from said double buffer in inverted form.

5. A camera according to claim 2, wherein the image is written in said double buffer in inverted form and the image is read said double buffer in normal form.

6. A camera according to claim 3, wherein the image is recorded in normal form when all of said plurality of memory means are used for write operation, and the image is read in inverted form from all of said plurality of memory means after the recording is completed.

7. A camera according to claim 3, wherein the image is recorded in inverted form when all of said plurality of memory means are used for write operation, and the image is read in normal form from all of said plurality of memory means after the recording is completed.

8. An image pickup system comprising:
a plurality of image pickup means;
a plurality of buffer memories for temporarily storing each of the data output from said plurality of image pickup means; and,
image combination means for combining image read from buffer memories.

9. A system according to claim 8, wherein said plurality of buffer memories are used as a double buffer which is switched between uses for write and read operations of image data output from said image pickup means.

10. A system according to claim 9, further comprising a color signal processing circuit for applying a predetermined color signal process to each image data output from said image pickup means, wherein said double buffer is provided in the stage subsequent to said color signal processing circuit.

11. A system according to claim 9, further comprising a signal processing circuit for applying a predetermined signal process to each image data output from said image pickup means, wherein said double buffer is provided in the stage preceding to said color signal processing circuit.

12. A system according to claim 11, further comprising a pixel thinning-out/interpolation circuit for applying pixel thinning-out or interpolation process to each of said image data in combining by said image combining means each image data from each of said plurality of image pickup means, wherein said double buffer is provided in the stage subsequent to said pixel thinning-out/interpolation circuit.

13. An image pickup system comprising;
a plurality of image pickup means;
a 3-D display being capable of displaying image three-dimensionally;
a buffer memory being used as a double buffer which temporarily stores the image data from said plurality of image pickup means and is switched between uses for write and read operations of the image data output from said image pickup means; and
image combining means for combining the image data read from said buffer memory.

14. A system according to claim 13, wherein said 3-D display is a rear-barrier display.

15. A system according to claim 13, wherein said 3-D display is a liquid crystal shutter display.

16. An image pickup system comprising;
right and left image pickup means;
right and left buffer memory means for temporarily storing image data read from said right and left image pickup means, respectively; and
image combining means for combining the image data read from said right and left buffer memory means,
wherein each of said right and left buffer memory means has a plurality of memories and is arranged so as to perform read and write operations of the image data concurrently at predetermined periods, and
wherein said image combining means combines image data output from each of said right and left buffer memory means to output a combined image data at predetermined periods.

17. A system according to claim 16, wherein said predetermined periods are field periods.

18. A system according to claim 17, further comprising an image memory for storing the combined image data output from said image combining means; and
displaying means for displaying the image stored in said image memory,
whereby the right and left image data combined by said right and left image pickup means is displayed in said field periods.

19. A system according to claim 16, wherein said right and left buffer memory means are controlled to be switched between write and read operations of said plurality of memory means alternately at predetermined periods, whereby write and read of image data to and from said buffer memory means are concurrently performed.

20. A system according to claim 17, further comprising a recording means for recording the image data read from said right and left buffer memory means in the recording medium, wherein said recording means records an attributes which indicates that the image data are right and left image data which make up a 3-D image along with said image data read from said right and left buffer memory means in said recording medium.

21. A system according to claim 18, further comprising a compression encoding means for compressing and encoding said image data and providing a compressed and encoded data to said display means.

22. A method for generating a 3-D image or panoramic image by storing image data output from a plurality of image pickup means in a plurality of buffer memories and combining the image data read from said plurality of buffer memory means, comprising steps of;
constructing each of said buffer memory means with plurality of memories;
performing write and read operations of the image data concurrently at predetermined periods; and
combining the image data output from said plurality of buffer memory means and outputting a combined image data in said predetermined periods.

23. A method according to claim 22, wherein said predetermined periods are field periods, and said combined image of plurality of image data picked up by said plurality of image pickup means is displayed at field periods on a display means by storing said combined image data in an image memory and displaying said stored image data on said display means.

24. A method according to claim 22, wherein said right and left buffer memory means are controlled to be switched between write and read operations of said plurality of memory means alternately at predetermined periods, whereby write and read of image data to and from said buffer memory means are concurrently performed.
